(19) United States
(12) Patent Application Publication
(10) Pub. No.: US 2026/0301747 A1
(43) Pub. Date: Oct. 1, 2026

(54) ENHANCING SPEECH COMPREHENSION WITH DIRECTIONAL HAPTICS

(71) Applicant: Adeia Guides Inc., San Jose, CA (US)

(72) Inventors: Aldis Sipolins, Somerville, MA (US); Toshiro Ozawa, Irvine, CA (US); Jean-Yves Couleaud, Mission Viejo, CA (US); Ning Xu, Irvine, CA (US)

(21) Appl. No.: 19/095,586

(22) Filed: Mar. 31, 2025

(51) Int. Cl. G10L 17/22; G06F 3/01

(52) U.S. Cl. CPC G10L 17/22; G06F 3/016; G06F 3/017

(57) ABSTRACT

Systems and methods are provided herein for enhancing speech comprehension with directional haptics. A haptic system identifies haptic actuators and microphones associated with users with hearing difficulties and/or users in a challenging listening environment. Based on detecting speech using the microphones, the haptic system identifies a direction of the speech relative to the haptic actuators and determines a haptic pattern corresponding to the speech. Based on the direction, the haptic system identifies haptic actuators to output the haptic pattern at and causes output of the haptic pattern at the haptic actuators.

### BACKGROUND

The present disclosure is directed towards techniques for enhancing speech comprehension with directional haptics, e.g., haptic patterns generated on devices.

### SUMMARY

Many people have hearing disabilities or impairments, due to a medical condition and/or due to advanced age, which hinders their ability to understand a conversation that they are participating in with others. A person having hearing disabilities or impairments, and/or any person in a challenging listening environment, may have trouble comprehending certain portions of conversations, especially when attempting to converse with multiple speakers, or when the person having hearing difficulties, and the people they are speaking with, are in motion. As used herein “a person having hearing difficulties” or “a user having hearing difficulties” may be understood to mean either a person with a hearing disability or a hearing impairment in any environment, a person who may not have any specific hearing disability or hearing impairment but is present in a challenging listening environment, or a person with a hearing impairment or hearing disability that is present in a challenging listening environment. A person having hearing difficulties is often frustrated and feels excluded from parts of the conversation. Moreover, even people that do not have a hearing disability or impairment may struggle to hear portions of a conversation in a generally challenging hearing and conversation comprehension scenario, e.g., a crowded public place with many voices, music, or other sounds or distractions, and/or environments where sound is blocked or attenuated.

In one approach, a hearing aid is employed to amplify, to a person having hearing difficulties, one or more voices of one or more other persons having a conversation with the person. However, while this is useful, particularly in a one-on-one conversation with little background noise, in a conversation with one or more people who may be in motion and/or with background noise, the hearing aid of the person having hearing difficulties, if used in isolation, may fail to provide a coherent, understandable amplified output of the detected sound to the person having hearing difficulties.

In another approach, the person having hearing difficulties may use a haptic device, such as a smartwatch with haptic actuators, to capture conversational audio using microphones, translate the phonemes present in the audio to haptic patterns, and generate the haptic patterns at haptic actuators on the haptic device, e.g., by emitting a vibrational pattern corresponding to the speech at the haptic actuators. Converting the audio signal directly to a haptic pattern is a way to supplement hearing in a way that can help improve speech comprehension. However, this approach, in at least some circumstances, may be deficient because it fails to account for the positions of one or more speakers, or of multiple speakers in an environment (e.g., who may be speaking over each other), and it fails to account for the spatial arrangement of one or more haptic devices and microphones in relation to users in the environment. Moreover, such approach may be difficult to implement for a conversation if the person having hearing difficulties and their conversational partner(s) are in motion and/or are otherwise experiencing a challenging listening environment.

To help address these problems, systems, methods, apparatuses, and computer-readable media, or more generally, techniques, are provided herein for enhancing speech comprehension with directional haptics. In some embodiments, a haptic system comprises one or more haptic actuators associated with a user. In some embodiments, the haptic system comprises a primary device (such as, for example, a smartphone and/or another haptics device) that is associated with a person having hearing difficulties, as well as other haptic devices that are associated with the primary device, e.g., through a linked iCloud account or other cloud-based account, or in communication by way of a Bluetooth connection, Wi-Fi connection, and/or any other suitable wireless connection or wired connection. In some examples, the haptic actuators are present on one or more haptic devices being held by, worn by, or otherwise associated with the person having hearing difficulties, e.g., there may be four haptic actuators on the four corners of a rectangular haptic-enabled smartwatch device worn by the person having hearing difficulties. In some embodiments, the one or more haptic actuators may be in contact with one or more portions of a skin of, and/or another portion of the body of, the person having hearing difficulties. In some examples, the haptic actuators are present on more than one haptic device being held by, worn by, or otherwise associated with the person having hearing difficulties, e.g., one or more haptic actuators may be includes in a haptic-enabled smartwatch device worn by the person having hearing difficulties, on a smartphone that the person is carrying in their hand or in their pocket, and/or on earbuds in the ears of the person. In some embodiments, one or more microphones are associated with the person having hearing difficulties in the environment. In some examples, the one or more microphones are included in the haptic system the person having hearing difficulties is associated with.

In some embodiments, the haptic system identifies a direction of a source of the speech (detected by the one or more microphones) relative to the haptic actuators and determines a haptic pattern corresponding to the speech. For example, the haptic system identifies that the source of the speech is two feet away and to the left of the haptic actuators from the perspective of the user, and translates the phonemes present in the speech into a haptic pattern to be generated at the haptic actuators. Based at least in part on the identified direction, the haptic system identifies one or more of the haptic actuators to output the haptic pattern and causes output of the haptic pattern at such one or more haptic actuators. For example, if the source of the speech is two feet away and to the left of the haptic actuators from the perspective of the user, a leftmost haptic actuator on the smartwatch on the left wrist of the person (and/or a haptic actuator associated with the user that is closest to the source of the speech) may output the haptic pattern.

Such aspects help to improve speech comprehension, while accounting for directional and other aspects of conversation. For example, different haptic patterns may be actuated in an intuitive way based at least in part on a direction of the source of the speech in relation to the person having hearing difficulties, enabling the person to not only better comprehend the words being said, but also to better keep track of where the speech is coming from in a dynamic environment in real time.

In some embodiments, the speech is spoken by more than one speaker in the environment. In some examples, when speech from multiple speakers is detected, distinct haptic patterns are generated at different haptic actuators of a same device, or at different devices worn by the person having hearing difficulties. The generation of the distinct haptic patterns may be based at least in part on where the multiple speakers are located and the speech spoken by each speaker. For example, if the haptic system determines that one speaker is on the left side of the person, and another speaker is on the right side of the person, the haptic system may actuate a haptic pattern associated with the speech of the left speaker on the smartwatch worn on the left wrist of the person, while the haptic system may actuate a different haptic pattern associated with speech of the right speaker on the smartphone held in the right hand of the person. In another example, such as where the haptic system determines that the person only has one haptic device, and that one speaker is on the left side of the person, and another speaker is on the right side of the person, the haptic system may actuate a different haptic pattern on the device based on the direction the sound comes from, e.g., to help differentiate which speaker is speaking. In another example, the person may select a speaker of the multiple speakers to focus on, e.g., by directing their gaze on that person or shifting their body position to face that person, detected by, e.g., a camera-enabled device (e.g., smart glasses) or a wrist-worn inertial measurement (or electromyography) device (e.g., a smartwatch). In this example, the haptic system may cause the output of the haptic pattern associated with the speech of the focused-on speaker to be emphasized over the haptic pattern associated with the speech of the other speakers.

Such aspects allow for using haptic feedback to enhance comprehension of conversations with multiple speakers in an environment, based on the direction and location of each speaker.

In some embodiments, one or more first haptic actuators of the plurality of haptic actuators are included in a first device; one or more second haptic actuators of the plurality of haptic actuators are included in a second device; and the identifying of the one or more haptic actuators is based at least in part on the identified direction in relation to a location of the first device and a location of the second device.

In some embodiments, the speech is first speech spoken by a first speaker, the direction is a first direction, the haptic pattern is a first haptic pattern, the one or more haptic actuators correspond to the one or more first haptic actuators configured to output haptic patterns associated with the first speaker. The techniques described herein may further comprise identifying a second speaker of second speech in the audio data, wherein each of the user, the first speaker, and the second speaker is distinct from each other; identifying a second direction of the second speaker relative to the plurality of haptic actuators; determining a second haptic pattern corresponding to the second speech; and causing, by the control circuitry, output of the second haptic pattern at the one or more second haptic actuators, wherein the one or more second haptic actuators contact a different portion of the user than the one or more first haptic actuators.

In some embodiments, the speech is first speech spoken by a first speaker, the direction is a first direction, the haptic pattern is a first haptic pattern, each of the plurality of haptic actuators is included in a device, and the one or more haptic actuators are included in a first subset of the plurality of haptic actuators configured to output haptic patterns associated with the first speaker. The techniques described herein may further comprise identifying a second speaker of second speech in the audio data, wherein each of the user, the first speaker, and the second speaker is distinct from each other; identifying a second direction of the second speaker relative to the plurality of haptic actuators; determining a second haptic pattern corresponding to the second speech; and, causing, by the control circuitry, output of the second haptic pattern at a second subset of the plurality of haptic actuators, wherein the second subset is configured to output haptic patterns from the second speaker, and wherein the second subset of the plurality of haptic actuators contacts a different portion of the user than the first subset of the plurality of haptic actuators.

In some embodiments, the haptic system identifies a distance between the source of the speaker and the haptic actuators, and the output of the haptic pattern at the haptic actuators is additionally or alternatively based on the distance. For example, if the haptic system determines that one speaker is farther away from a person having hearing difficulties than another speaker, the haptic system may generate a first (e.g., relatively weaker vibration) haptic pattern for speech of the farther speaker and a second (e.g., relatively stronger vibration) haptic pattern for the closer speaker. In some embodiments, the haptic system identifies an updated location of the source of the speech and generates a new haptic pattern accordingly. For example, if the haptic system detects that a speaker is in motion or has moved from a previous location, the haptic system identifies the new distance between the source of the new speech and/or the haptic actuators and the new direction of the source of the new speech relative to the haptic actuators. Based on such information, the haptic system may determine a new haptic pattern based on the new speech, identify one or more different haptic actuators, and causes output of a second haptic pattern at the identified one or more different haptic actuators. In another example, the haptic system identifies a change in the orientation of the haptic actuators and adjusts the output of the haptic pattern at the actuators accordingly. For example, if a user is wearing a smartwatch with one or more haptic actuators, the haptic system may detect a change in an orientation of the smartwatch changes, e.g., if the person wearing the smartwatch rotates their wrist, and a haptic actuator that is, for example, closest to a speaker as a result of the orientation change may be selected for putting a haptic pattern corresponding to speech of the speaker.

Such aspects allow for the enhanced comprehension of conversations with speakers in motion within an environment, dynamically updating haptic patterns based on the changing locations and positions of speakers and haptic actuators.

In some embodiments, the haptic system generates the haptic pattern at the actuators based on emphasized words within the speech. For example, if a speaker says, “I just cannot believe she went to the park today, of all days!” the haptic pattern may include a more pronounced vibration for the word “today” in relation to the other words of the phrase or sentence. In some embodiments, the haptic system also generates the haptic pattern for output at the one or more haptic actuators based at least in part on physical gestures of the speaker, detected by, e.g., a camera-enabled device (e.g., smart glasses) or a wrist-worn inertial measurement (or electromyography) device (e.g., a smartwatch). For example, if the haptic system determines that a speaker is waving their arms while saying a particular word or phrase, the haptic pattern may include a more pronounced vibration for that particular word or phrase.

In some embodiments, the haptic system determines whether an identity of a speaker matches stored information corresponding to distinct speaker identities. The speaker identity information may be stored in association with a user profile of the person having hearing difficulties. For example, the haptic system may store, in relation to the user profile of the person having hearing difficulties, the voice characteristics of their spouse or other friends, family members or other persons the person has had conversations with, and the haptic system may identify that, for example, the spouse of the person is currently speaking. In some implementations, the haptic system then determines the haptic pattern based on preset preferences stored in the user profile for that particular speaker identity. For example, input may have been received from the person having hearing difficulties indicating that all haptic patterns corresponding to speech from their spouse should be generated at their smartwatch and/or using a particular type of vibration pattern.

Such aspects allow for enhanced personalization and customization of haptic patterns, enhancing comprehension of speech and making following conversations easier for people with hearing difficulties.

In some embodiments, the systems or techniques disclosed herein may detect speech using microphones embedded in consumer electronics (e.g., smartwatch, smartphone, smart glasses). For each available microphone, the systems or techniques disclosed herein may determine the distance and direction of the speaker and identify the relative spatial positions of haptic devices. For each available haptic device, the systems or techniques disclosed herein may generate a haptic pattern based on derived haptic device distance from the speaker. In some embodiments, the systems or techniques disclosed herein may deliver the haptic pattern while updating device position and adjusting the haptic pattern in real time. In some embodiments, such systems or techniques disclosed herein may be applied in isolation or alongside hearing aids or earbuds.

In some embodiments, the systems or techniques disclosed herein may present haptic patterns for multiple detected speakers at the same time. In some embodiments, the systems or techniques disclosed herein may adjust haptic patterns based on the position and/or rotation of haptic devices. In some embodiments, the systems or techniques disclosed herein may adjust haptic patterns based on the spatial arrangement of detected speakers, and/or adjust haptic patterns based on word emphasis.

In some embodiments, the systems or techniques disclosed herein may help provide for conversion of audio to haptic patterns; adjustment of haptic strength based on sound direction; improved comprehension of a voice amidst background noise; improved comprehension of multiple concurrent voices; adjustment of haptic patterns based on word emphasis; and/or adjustment of haptic patterns based on relative direction of multiple speakers.

In some embodiments, the systems or techniques disclosed herein may identify a specific speaker in real time and boost their volume amidst other voices and background noise, also described in commonly-owned U.S. application Ser. No. 18/669,906, filed May 21, 2024, the contents of which are hereby incorporated by reference herein in their entirety.

### BRIEF DESCRIPTION OF THE DRAWINGS

The present disclosure, in accordance with one or more various embodiments, is described with reference to the following figures. The drawings are provided for purposes of illustration only and merely depict typical or example embodiments. These drawings are provided to facilitate an understanding of the concepts disclosed herein and do not limit the breadth, scope, or applicability of these concepts. It should be noted that for clarity and ease of illustration these drawings are not necessarily made to scale.

FIGS. 1-3 are illustrative examples of a haptic system for enhancing speech comprehension with directional haptics, in accordance with some embodiments of the present disclosure;

FIG. 4 is a sequence diagram for using a second device to acquire higher quality audio to generate a suitable directional haptic response, in accordance with some embodiments of the present disclosure;

FIG. 5 is a flowchart of an illustrative process for enhancing speech comprehension with directional haptics, in accordance with some embodiments of the present disclosure;

FIG. 6 is a sequence diagram for enhancing speech comprehension with directional haptics, in accordance with some embodiments of the present disclosure;

FIG. 7 is an illustrative example of speaker diarization extracting speech data for at least two speakers from a single audio source, in accordance with some embodiments of the present disclosure;

FIG. 8 is a diagram of an illustrative media device, in accordance with some embodiments of this disclosure; and

FIG. 9 is a diagram of an illustrative system for enhancing speech comprehension with directional haptics, in accordance with some embodiments of this disclosure.

### DETAILED DESCRIPTION OF EMBODIMENTS OF THE DISCLOSURE

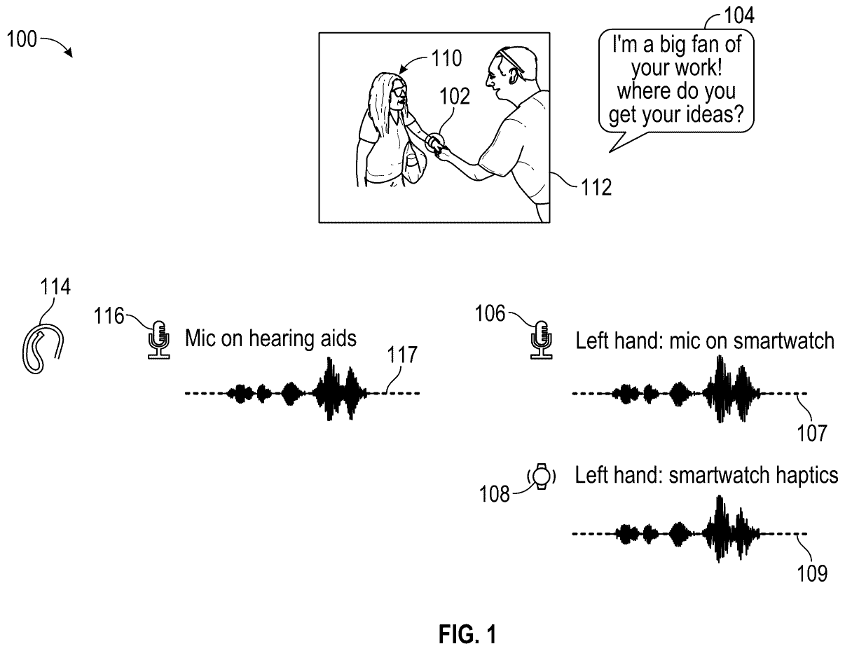

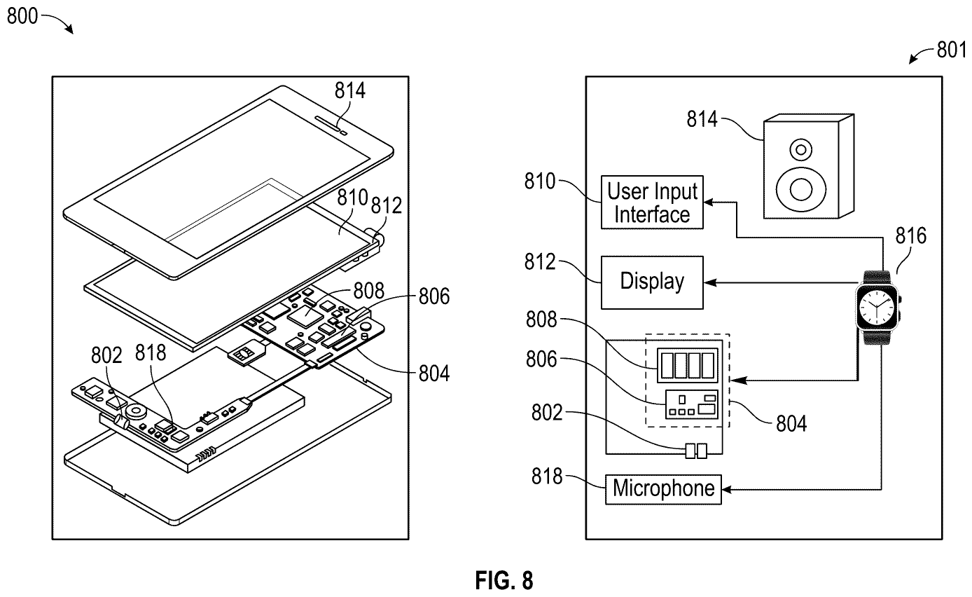

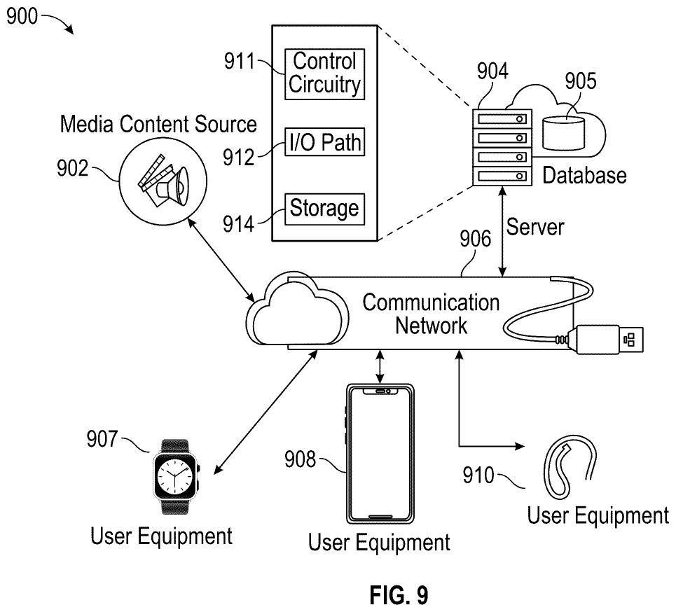

FIG. 1 is an illustrative example of a system for enhancing speech comprehension with directional haptics, in accordance with some embodiments of the present disclosure. Haptic system 100 may comprise any suitable number of haptic actuators, microphones, haptic devices, other computing (haptic or non-haptic) devices, sensors, servers, databases, communication networks, or any other suitable components, or any suitable combination thereof. Haptic system 100 may be configured to perform the functionalities (or one or more portions thereof) described herein. In some embodiments, haptic system 100 may comprise or be incorporated as part of any suitable platform, application, or software program. In some embodiments, haptic system 100 may be implemented at least in part by control circuitry of haptic device 102. For example, non-transitory memories of one or more components of haptic device 102, and/or devices of FIGS. 8 and 9 (e.g., storage 914) may store instructions that, when executed by the control circuitry of the device 102, and/or devices of FIGS. 8 and 9 (as described further below with reference to FIGS. 8 and 9), cause execution of the process depicted in FIG. 1. The processes or techniques of FIG. 1 may be used with any other embodiment of this disclosure. In addition, the processes and techniques described in relation to FIG. 1 may be done in suitable alternative orders or in parallel to further the purposes of this disclosure.

In some embodiments, haptic system 100 includes haptic device 102, e.g., a smartwatch, a smartphone, a tablet, smart glasses, smartwatch, an extended reality (XR) device, earbuds, hearing aids, headphones, an article of smart clothing, a game controller, a wristband or other wearable device and the like. In the example of FIG. 1, user 110 may be having a conversation (e.g., an in-person conversation) with user 112. User 110 and/or user 112 may be a person having hearing difficulties, as described herein. User 110 may be wearing, holding, or otherwise associated with haptic device 102 and one or more hearing aids 114. In some embodiments, haptic device 102 includes one or more microphones 106 and one or more haptic actuators 108. Additionally or alternatively, one or more microphones 116 and/or one or more haptic actuators 108 may be included in a different device than haptic device 102, e.g., in one or more hearing aids 114 which may be being worn by user 110, such as in or around a right ear of the user 110 and/or in or around a left ear of user 110. In an example, haptic device 102 is a smartwatch worn by a user 110, and one or more hearing aids 114 comprise one or more microphones 116. In some embodiments, user 110 may be a hearing-impaired user and/or may struggle to hear speech 104 of user 112 or otherwise be a user in a challenging listening environment. While speech 104 is shown as coming from user 112 (a human being physically present next to user 110, another human being), it should be appreciated that speech may originate from any suitable source, e.g., a television, a computer, a smartphone, a loudspeaker, or the like, in any suitable environment

In some embodiments, haptic device 102 uses the one or more microphones 106 and/or the one or more microphones 116 to detect speech 104, e.g., audio data including the words “I'm a big fan of your work! Where do you get your ideas?” spoken aloud by user 112 (and which may be converted to text using any suitable transcription technique, e.g., automatic speech recognition (ASR) techniques. In some embodiments, sound waveform 107 represents speech 104 detected by one or more microphones 106 (e.g., of haptic device 102) and sound waveform 117 represents speech 104 detected by one or more microphones 116 (e.g., of one or more hearing aids 114). These illustrative waveforms show how the amplitude of the sound of speech 104 varies over the course of the spoken sentences or phrases in speech 104 as detected by one or more microphones 106 and one or more microphones 116. In some embodiments, sound waveform 107 and/or sound waveform 117 are converted to a haptic pattern, represented by vibration waveform 109. As described in more detail below, haptic system 100 may analyze characteristics of such sound waveforms to determine a direction (and/or distance, and/or any other suitable attribute) from user 110 and haptic actuators 108 in relation to a location or source from which speech 104 originates, and such analysis may inform a manner of outputting, and at which device to output, a haptic pattern corresponding to the detected speech.

In some embodiments, haptic system 100 uses one or more vocoders to convert an audio frequency range (e.g., of audio signals associated with sound waveform 107 and/or 117) to one or more corresponding haptic frequency ranges to which humans are particularly sensitive. This approach may use a single frequency band or it may use multiple frequency bands. In some embodiments, converting audio (e.g., speech 104) to a corresponding haptic pattern (e.g., the haptic pattern represented by vibration waveform 109) involves constructing a temporal envelope (e.g., an amplitude envelope) around the audio signal, which is then processed and transmitted as a haptic pattern to the haptic actuators (such as, for example, haptic actuators 108 of haptic device 102). In some embodiments, the audio is converted to a tactile signal using the one or more vocoders to convert the audio frequency range to the haptic frequency range to which the human tactile system is particularly sensitive (e.g., around 250 Hz, and/or within 20 Hz to 1000 Hz). In some embodiments, to obtain a haptic pattern corresponding to waveform 109, audio is first filtered into frequency bands, and the amplitude envelope is then extracted for each band and used to modulate the amplitude of the generated haptic pattern. This is discussed in more detail in Răutu et al., “Speech-derived haptic simulation enhances speech recognition in a multi-talker background,” Scientific Reports (2023) 13:16621, nature portfolio, the contents of which are hereby incorporated by reference herein in their entirety. The haptic pattern may be a vibrational pattern, generated and/or output at, for example, the one or more haptic actuators 108 of haptic device 102, and the haptic pattern may correspond to the detected speech at the haptic actuators.

The haptic pattern may be used to complement or supplement comprehension of the detected speech by user 110. For example, haptics may be well suited to supplementing the comprehension of heard speech because vibrotactile and auditory input are processed in nearby brain areas, with some auditory areas even responding to vibrotactile stimulation. In some embodiments, by assigning haptic codes to individual phonemes, the smallest units of speech, the haptic system 100 may enable a user to understand words and sentences entirely or partially using haptic feedback. For example, phonemes of detected speech may be converted to haptic patterns. As another example, the haptic system 100 may convert an audio signal directly to a haptic pattern, to help enhance speech comprehension by supplementing detected speech with a congruent haptic pattern.

In some embodiments, relative hearing ability of user 110 may be used, at least in part, to adjust the amplitude of generated haptic patterns based on hearing test results, e.g., a test provided by haptic system 100 to user 110 prior to detecting speech 104. In such examples, haptic system 100 may retrieve a hearing profile of user 110 created via a calibration process such as a hearing test that generates a number representing hearing loss in each ear. Such a profile may include information on relative hearing ability of the left and right ear. For example, if a user 110 is determined to have worse hearing in their right ear than their left ear, haptic system 100 may, in this scenario, output a haptic pattern having a higher strength and/or a higher frequency on a right side of the user as compared to haptic pattern output at a left side of the user.

In some embodiments, the haptic system may identify a regional accent, or user 110 may select a relevant regional accent (e.g., Boston or New York within the same country or region, or a different foreign country or region). In such examples, the haptic system may load a set of parameters associated with a particular accent, which may be used to interpret accented speech (e.g., understand that “yahd” means “yard” if a Boston accent is detected or selected) or modify haptic patterns (e.g., generate the haptic pattern for “yard” upon hearing “yahd” if a Boston accent is detected or selected for user 112 speaking to user 110). On the other hand, if both user 110 and user 112 have the same accent, e.g., a Boston accent or are otherwise from the same geographic area (e.g., Boston), it may be acceptable to output a haptic pattern for “yahd” to user 110 and/or user 112.

In some embodiments, the haptic pattern represented by vibration waveform 109 is then actuated or output at the one or more haptic actuators 108 of haptic device 102, to supplement or enhance comprehension of the detected audio. In some embodiments, the one or more haptic actuators 108 may be independent of a particular device, such as haptic device 102. In some embodiments, one or more haptic actuators 108 of haptic device 102 may emit the vibrations emulating the haptic pattern represented by vibration waveform 109. In some embodiments, some but not all of the haptic actuators 108 on haptic device 102 may emit the vibrations emulating the haptic pattern represented by vibration waveform 109. For example, haptic system 100 may cause only the haptic actuators on the left side of haptic device 102 (in relation to user 110) to emit the vibrations, based on the haptic system 100 determining that a sound source (e.g., the speech 104) originates from a direction that is associated with a left side of the user 110 wearing haptic device 102. For example, the haptic system 100 may determine that the volume of speech 104 is louder on the microphones on the left side of user 110 (e.g., amongst microphones within haptic device 102, or as compared to one or more microphones 116 of one or more hearing aids 114 located on a right side of user 110 or a smartphone located on a right side of user 110), and therefore that the source of the sound (e.g., speech 104) is likely to be originating at a left-hand side of the user. In some examples, the direction that speech 104 is coming from is determined based at least in part on one or more images captured by one or more cameras, e.g., cameras coupled to or part of haptic device 102 or other cameras associated with user 110, such as, for example, by analyzing the one or more images to compare a location of user 110 to user 112.

In some embodiments, the haptic system may determine a direction of speech 104 in relation to user 110 (and/or a distance between user 110 and user 112) based at least in part on device metadata. For example, the device metadata may indicate the positions of each haptic actuator relative to each other (and/or the positions of various microphones relative to each other) and/or the positions of haptic actuators in relation to the various microphones. For example, the haptic system 100 may determine that a user typically wears haptic watch on their left wrist. The device metadata may indicate which devices are capable of haptics. As another example, the haptic system 100 may localize the various microphones, devices (e.g., of user 110 and/or user 112), and/or haptic devices based on wireless signal characteristics (e.g., signal strength). In some embodiments, the haptics or vibrations output by haptic actuators 108 may be used to supplement speech 104, where speech 104 may (or may not) be processed using one or more hearing aids 114 worn by user 110. For example, the output of the haptics and the output by the one or more hearing aids 114 may be provided simultaneously, or substantially simultaneously. In some embodiments, the hearing aid corresponds to ear buds.

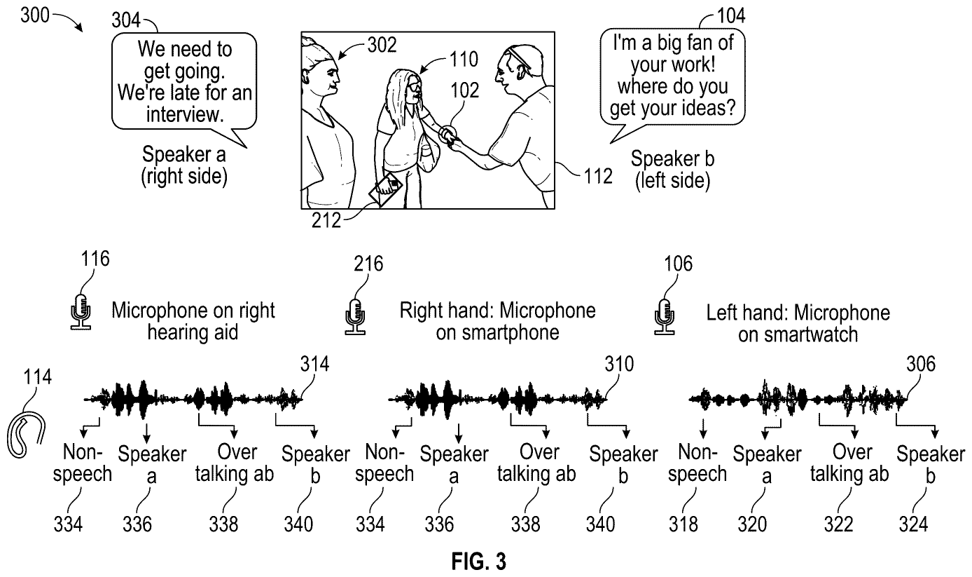

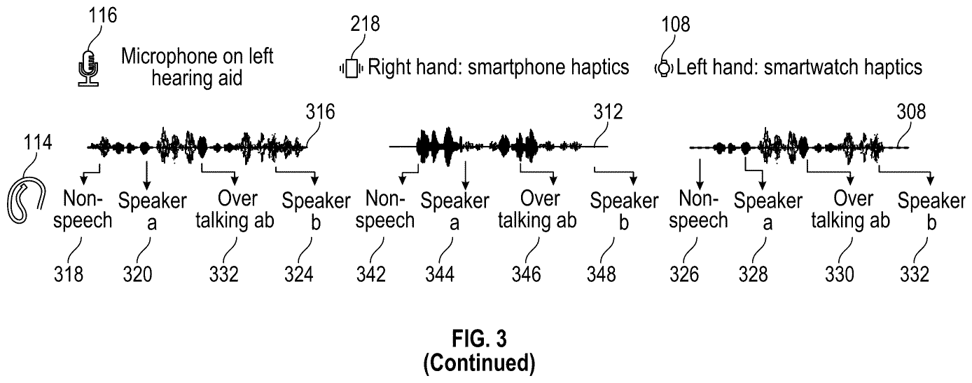

In some embodiments, the haptic system 100 may determine a direction in relation to user 110, and/or distance between user 110 and user 112, for each individual haptic actuator independently. For example, haptic device 102 may comprise multiple haptic actuators contacting user 110 at different portions of the user (e.g., different portions of a same body part, such as, for example, around a wrist or at right and left sides of a wrist, or at different body parts, such as, for example, a wearable sweater comprising haptic actuators contacting various portions of a torso of user 110), and/or multiple haptic actuators may be present across different devices contacting or associated with user 110. For example, haptic system 100 may control subsets of such multiple actuators to output haptic patterns for different sound sources (e.g., as shown in FIG. 3). As a non-limiting example, a smart glasses device or the like may comprise haptic actuators in both right and left temple arms of the smart glasses, and such actuators may be selectively activated based on a direction of detected speech and/or an identify of a speaker of the speech (e.g., a right temple arm may output a haptic actuator when the direction of the speech corresponds to a right-hand direction in relation to the user. In some embodiments, a direction from which speech 104 originates, in relation to user 110, may be inferred based at least in part on such a determination, e.g., the direction may correspond to a direction of a plane or a straight line extending from the closer of such devices.

In some embodiments, the haptic system 100 may generate haptic patterns for each haptic actuator, rather than for each haptic device. For example, device metadata may indicate the positions of each haptic actuator relative to the device, enabling the system to calculate distance from a speaker for each individual haptic actuator independently. For example, haptic device 102 may actuate a single haptic actuator if it is a smartwatch containing a single or relatively small number of haptic actuators. In another example, if haptic device 102 is a smart shirt with haptic actuators spread throughout and contacting various portions of a torso or other portion of user 110, haptic device 102 may generate different haptic patterns or vibrations for output at actuators located at or in a vicinity of the left and right sides of the shirt (or at any other suitable location of haptic actuators of the smart shirt). In another example, the actuators on the left side of the smart shirt (in relation to user 110) are actuated when speech 104 is on the left side of the user 110, and the actuators on the right side (in relation to user 110) of the smart shirt are actuated when speech 104 is on the right side of the user 110. Alternatively, device metadata may identify haptic groups (e.g., actuators clustered around the left wrist, actuators clustered around the right shoulder), where the same or similar vibration(s) is output at all of the haptic actuators in the haptic group, to reduce the processing for generating unique haptic patterns for each haptic actuator.

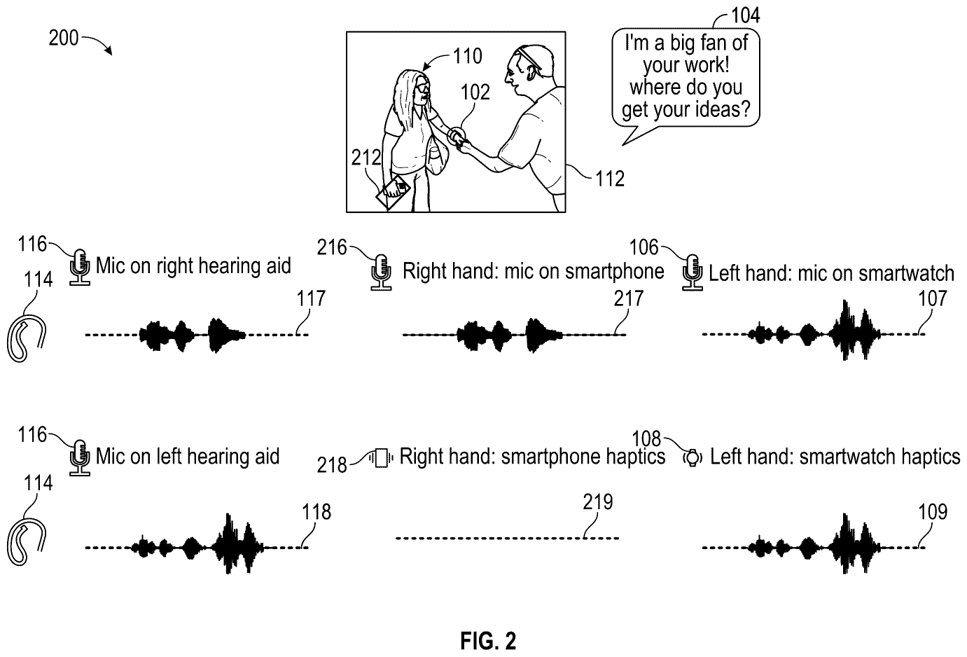

FIG. 2 is an illustrative example of a system for enhancing speech comprehension with directional haptics, in accordance with some embodiments of the present disclosure. In some embodiments, haptic system 200 includes haptic device 102 (e.g., a smartwatch) and second haptic device 212 (e.g., a smartphone). Haptic system 200 may correspond, at least in part, to haptic system 100 of FIG. 1 and haptic system 300 of FIG. 3). In some embodiments, haptic device 102 includes one or more microphones 106 and one or more haptic actuators 108. Additionally, or alternatively, one or more microphones 116 and/or one or more haptic actuators 108 may be included in a different device than haptic device 102, e.g., hearing aids 114 which may be being worn by user 110, such as in or around a right ear of the user 110. In an example, haptic device 102 is a smartwatch worn by a user 110, and hearing aids 114 comprise one or more microphones 116. In some embodiments, second haptic device 212 includes one or more microphones 216 and one or more haptic actuators 218. Second haptic device 212 may be, for example, a smartwatch, a smartphone, a tablet, smart glasses, an extended reality (XR) device, earbuds, hearing aids, headphones, an article of smart clothing, a game controller, a wristband or other wearable device and the like.

In various embodiments, the individual steps of a process performed by haptic system 200 may be implemented by the control circuitry of haptic device 102 and/or second haptic device 212. For example, non-transitory memories of one or more components of haptic device 102 or second haptic device 212 and devices of FIGS. 8 and 9 (e.g., storage 914 and control circuitry 911) may store instructions that, when executed by the control circuitry of the device(s) of FIGS. 8 and 9 (as described further below with reference to FIGS. 8 and 9), cause execution of the process depicted in FIG. 2. The processes or techniques of FIG. 2 may be used with any other embodiment of this disclosure. In addition, the processes and techniques described in relation to FIG. 2 may be done in suitable alternative orders or in parallel to further the purposes of this disclosure.

In the example of FIG. 2, user 110 may be having a conversation (e.g., an in-person conversation) with user 112. User 110 and/or user 112 may be a person having hearing difficulties, as described herein. User 110 may be wearing, holding, or otherwise associated with haptic device 102, second haptic device 212 (e.g., in a pocket of user 110), and one or more hearing aids 114. In some embodiments, haptic device 102 and second haptic device 212 uses the one or more microphones 106 and the one or more microphones 216, respectively, to detect speech 104, e.g., audio data including the words “I'm a big fan of your work! Where do you get your ideas?” spoken aloud by user 112 (and which may be converted to text using any suitable transcription technique, e.g., ASR techniques. In some embodiments, only one of haptic device 102, second haptic device 212, or one or more hearing aids 114 is a primary device. For example, the primary device is second haptic device 212 (e.g., a smartphone and/or another haptics device associated with user 110, haptic device 102, haptic device 212, and one or more hearing aids 114. In some examples, the primary device is associated with the user and the other devices through a linked iCloud or other cloud-based account, or in communication with such devices by way of a Bluetooth connection, Wi-Fi connection, and/or any other suitable wireless connection or wired connection. In some embodiments, the primary device uses only its own one or more respective microphones and/or the microphones of one or more of the linked devices (e.g., one or more microphones 116 of one or more hearing aids 114 and/or haptic device 212) to detect speech 104 (and then emits haptic patterns at the other associated devices or the same devices that detected the speech). In some embodiments, speech 104 detected at haptic device 102 corresponds to sound waveform 107, showing how the amplitude of the sound of speech 104 varies over the course of the sentences or phrases spoken in speech 104 as detected by haptic device 102. In some embodiments, a representation of speech 104 detected at second haptic device 212 (or another device of haptic system 200) corresponds to second sound waveform 217, which indicates how the amplitude of the sound of speech 104 varies over the course of the sentences or phrases spoken in speech 104 as detected by haptic device 212 (and/or another device of FIG. 2 having a microphone).

In some embodiments, sound waveform 107 has higher amplitudes and/or volumes at the same respective timepoints than sound waveform 217, indicating that a source of speech 104 (e.g., user 112) is closer to haptic device 102 than to haptic device 212. In some embodiments, a direction from which speech 104 originates, in relation to user 110, may be inferred based at least in part on such a determination, e.g., the direction may correspond to a direction of a plane or a straight line extending from the closer of such devices. In some embodiments, sound waveform 107 and sound waveform 217 are converted to haptic patterns, represented by vibration waveform 109 and vibration waveform 219, respectively. Based on the haptic system 200 determining that the source of speech 104 (e.g., user 112) is closer to haptic device 102 than haptic device 212, vibration waveform 219 does not depict any vibrational amplitude, as haptic system 200 may cause the haptic pattern to be actuated vibrationally only at haptic device 102. In some embodiments, the haptic pattern represented by vibration waveform 109 is then actuated at the one or more haptic actuators 108 on haptic device 102.

In some embodiments, one or more first haptic actuators of a plurality of haptic actuators are included in a first device, and one or more second haptic actuators of the plurality of haptic actuators are included in a second device, and identification of one or more haptic actuators at which to output a haptic vibration may be determined based at least in part on and identified direction of the source of sound, in relation to a location of the first device and a location of the second device. For example, when haptic system 200 (e.g., via a primary device, which may be the same as or different from hearing aids 114) is using, for example, the one or more microphones 116 of one or more hearing aids 114 to detect speech 104, the primary device detects that sound waveform 118 from the microphones on a left hearing aid of one or more hearing aids 114 has higher amplitudes and/or volumes at the same respective timepoints than sound waveform 117 from the microphones on a right hearing aid of one or more hearing aids 114, indicating that speech 104 is louder on the left side of user 110 than the right side of user 110. In some embodiments, sound waveform 117 and sound waveform 118 are converted to haptic patterns, represented by vibration waveform 219 and vibration waveform 109, respectively. Based on determining that speech 104 is louder on the left side of user 110 and haptic device 212 is on the right side of user 110, vibration waveform 219 does not depict any vibrational amplitude, as haptic system 200 may cause the haptic pattern to be actuated vibrationally only at haptic device 102 (which is on the left side of user 110). In some embodiments, the haptic pattern represented by vibration waveform 109 is then actuated at the one or more haptic actuators 108 on haptic device 102.

FIG. 3 is an illustrative example of a haptic system 300 for enhancing speech comprehension with directional haptics, in accordance with some embodiments of the present disclosure. In some embodiments, haptic system 300 (which may correspond at least in part to haptic system 100 of FIG. 1 and haptic system 200 of FIG. 2) includes haptic device 102 (e.g., a smartwatch) and second haptic device 212 (e.g., a smartphone). In some embodiments, haptic device 102 includes one or more microphones 106 and one or more haptic actuators 108. Additionally, or alternatively, one or more microphones 116 and/or one or more haptic actuators may be included in a different device than haptic device 102, e.g., one or more hearing aids 114 and/or haptic device 212. For example, haptic device 102 is a smartwatch worn by a user 110, and one or more hearing aids 114 comprises one or more microphones 116. In some embodiments, second haptic device 212 includes one or more microphones 116 and/or one or more haptic actuators 108. In various embodiments, the individual steps of a process performed by haptic system 300 may be implemented by the control circuitry of haptic device 102 or second haptic device 212 (and/or at least in part using a remote server). For example, non-transitory memories of one or more components of haptic device 102 or second haptic device 212 and devices of FIGS. 8 and 9 (e.g., storage 914 and control circuitry 911) may store instructions that, when executed by the control circuitry of the device(s) of FIGS. 8 and 9 (as described further below with reference to FIGS. 8 and 9), cause execution of the process depicted in FIG. 3. The processes or techniques of FIG. 3 may be used with any other embodiment of this disclosure. In addition, the actions and descriptions described in relation to FIG. 3 may be done in suitable alternative orders or in parallel to further the purposes of this disclosure.

In the example of FIG. 3, user 110 may be having a conversation (e.g., an in-person conversation) with user 112 and user 302. User 110 and/or user 112 and/or user 302 may be a person having hearing difficulties, as described herein. User 110 may be wearing, holding, or otherwise associated with haptic device 102, one or more hearing aids 114, and/or haptic device 212 (e.g., in a pocket of user 110). In some embodiments, haptic device 102 and second haptic device 212 uses the one or more microphones 106 and the one or more microphones 116, respectively, to detect speech 104, e.g., audio data including the words “I'm a big fan of your work! Where do you get your ideas?” spoken aloud by a user 112, and speech 304, e.g., audio data including the words “We need to get going. We're late for an interview.” spoken aloud by user 302 (each of which may be converted to text using any suitable transcription technique, e.g., ASR techniques. In some embodiments, only one of haptic device 102, one or more hearing aids 114, or second haptic device 212 is a primary device (such as, for example, a smartphone and/or another haptics device) associated with user 110, haptic device 102, haptic device 212, and one or more hearing aids 114, e.g., through a linked iCloud account or other cloud-based account, or in communication by way of a Bluetooth connection, Wi-Fi connection, and/or any other suitable wireless connection or wired connection, that uses only its own one or more respective microphones and/or the one or more microphones 116 of one or more hearing aids 114 and/or haptic device 212 to detect speech 104 and/or speech 304 (and may emit haptic patterns at the other associated devices or the same devices that detected the speech).

In some embodiments, sound waveform 306 may be a representation of speech 104 and speech 304 detected at one or more microphones 106 at haptic device 102. Sound waveform 306 indicates how the amplitude of the sound of speech 104 and 304 varies over the course of one or more words, terms or sentences spoken in speech 104 and 304 (indicated at sections 320 and 324, respectively), as well as the silences (non-speech, or filtered out background noise, indicated at 318) and overlapping speech from both speech 104 and 304 (indicated at 322), as detected by the one or more microphones 106 of haptic device 102. In some embodiments, sound waveform 316 may be a representation of speech 104 and speech 304 detected at one or more microphones 106 of the left hearing aid of one or more hearing aids 114 Sound waveform 316 indicates how the amplitude of the sound of speech 104 and 304 varies over the course of one or more words, terms, or sentences spoken in speech 104 and 304, as well as the silences (non-speech or filtered out background noise indicated at 318) and overlapping speech from both speech 104 and 304 (indicated at 322), as detected by the one or more microphones 116 of the left hearing aid of one or more hearing aids 114. In some embodiments, haptic system 300 determines that sound waveform 306 and sound waveform 316 both include a section 318 representing non-speech, a section 320 representing speech 304 alone, a section 322 representing speech 104 and speech 304 overlapping, and a section 324 representing speech 104 alone. For example, the same or substantially similar waveform 306 and 316 may be detected by microphones associated with a particular side (e.g., right side) of a body of user 110. It should be appreciated that, in some embodiments, waveforms 306 and 316 may differ from each other, based on, for example, detecting sound differently at their respective microphones, even if located on a same side or similar location associated with user 110.

In some embodiments, sound waveform 310 depicts a visual representation of speech 104 and speech 304 detected at one or more microphones 116 of haptic device 212. Sound waveform 310 illustrates how the amplitude of the sound of speech 104 and 304 varies over the course of one or more words, terms, or sentences spoken in speech 104 and 304 (indicated at 336 and 340, respectively), as well as the silences (non-speech or filtered out background noise indicated at 334) and overlapping speech from both speech 104 and 304 (indicated at 338. In some embodiments, sound waveform 314 represents speech 104 and speech 304 detected by one or more microphones 116 of the right hearing aid of one or more hearing aids 114., Sound waveform 314 shows how the amplitude of the sound of speech 104 and 304 varies over the course of the sentences spoken in speech 104 and 304 (indicated at 336 and 340, respectively), as well as the silences (non-speech or filtered out background noise indicated at 334) and overlapping speech from both speech 104 and 304 (indicated at 338). In some embodiments, sound waveform 310 and sound waveform 314 both include a section 334 representing non-speech or filtered out background noise, a section 336 representing speech 304 alone, a section 338 representing speech 104 and speech 304 overlapping, and a section 340 representing speech 104 alone. For example, the same or substantially similar waveform 310 and 314 may be detected by microphones associated with a particular side (e.g., left side) of a body of user 110. It should be appreciated that, in some embodiments, waveforms 310 and 314 may differ from each other, based on, for example, detecting sound differently at their respective microphones, even if located on a same side or similar location associated with user 110.

Based on such waveforms 306, 310, 314, and 316, haptic system 300 may identify a direction (and/or distance and/or other characteristics) in relation to user 302 uttering speech 304 and user 110 having hearing difficulties, and a direction (and/or distance and/or other characteristics) in relation to user 112 uttering speech 104 and user 110. For example, based on determining that one or more amplitudes associated with section 336 (e.g., associated with audio detected by one or more microphones 116 on right side of user 110 at a first timepoint) exceed or more amplitudes associated with a corresponding section 320 (e.g., associated with audio detected by one or more microphones 106 on left side of user 110 at the same first timepoint), haptic system 300 may determine that user 302 uttering speech 304 is closer to a right hand side of the user as opposed to a left-hand side of user 110. For example, the first timepoint may correspond to a same positional point across the respective waveforms, indicating the speech was spoken at the same time, possibly by the same user.

As another example, based on determining that one or more amplitudes associated with section 324 (e.g., associated with audio detected by one or more microphones 116 on left side of user 110 at a second timepoint) exceed or more amplitudes associated with a corresponding section 340), haptic system 300 may determine that user 302 uttering speech 304 is closer to a left-hand side of the user 110 as opposed to a right-hand side of user 110. For example, the second timepoint may correspond to a same positional point across the respective waveforms, indicating the speech was spoken at the same time, possibly by the same user.

In some examples, the higher amplitude (e.g., speech volume) of corresponding sections of the respective sound waveform indicate sections of detected speech that were closer to the respective device corresponding to each respective sound waveform. For example, section 336 representing speech 304 on sound waveform 310 has a higher amplitude than section 320 representing speech 304 on sound waveform 306, indicating that a source of speech 304 (e.g., user 302) is closer to second haptic device 212 than to haptic device 102. In some embodiments, a direction from which speech 304 originates, and direction from which speech 104 originates, in relation to user 110, may be inferred based at least in part on such a determination, e.g., each direction may respectively correspond to a direction of a plane or a straight line extending from the device having the higher amplitude.

In some embodiments, sound waveform 306 and sound waveform 310 are converted to haptic patterns, represented by haptic pattern or vibration waveform 308 and haptic pattern or vibration waveform 312, respectively. Vibration waveform 308 may comprise non-speech section 326, user 112 section 328, overlapping speech section 330, and user 302 section 332, each having haptic patterns corresponding to respective audio sections 318, 320, 322, and 324, respectively. Vibration waveform 312 may comprise non-speech section 342, user 112 section 344, overlapping section 346, and user 302 section 348, each having haptic patterns corresponding to respective audio sections 334, 336, 338, and 340, respectively. In some embodiments, the haptic pattern represented by vibration waveform 308 is then actuated at the one or more haptic actuators 108 on haptic device 102 (and/or at another device located at a left-hand side of user 110). In some embodiments, the haptic pattern represented by vibration waveform 312 is then actuated at the one or more haptic actuators 218 on haptic device 212 (and/or at another device located at a right-hand side of user 110). In some embodiments, the haptic patterns are provided at the same or near the same time that user 110 hears speech 104 and speech 304 either directly through her ears or via one or more hearing aids 114, for example, with a wireless communication link between one or more hearing aids 114 and the haptic devices using protocols such as Bluetooth Low Energy (BLE) and Near-Field Communication (NFC) and/or any other suitable connection, e.g., a Wi-Fi network.

In some embodiments, for portions of speech 104 and 304 that overlap, at least one of such audio portions (and corresponding haptic pattern) may be recorded and delayed, to allow user 110 to focus on one of such portions at a time. For example, the haptic system 100 may prioritize, e.g., provide in real time or near-real time, haptic patterns and/or audio signals associated an overlapping portion of speech 104 or speech 304 that is determined to originate from a preferred speaker, contain certain keywords, and/or that has a higher amplitude, and play back the other audio signal and/or haptic pattern at a later time (e.g., when non-speech is next detected, or based on user input). In some embodiments, haptic system 300 uses timestamping and audio signal processing techniques to match the temporal characteristics of the auditory signals with the haptic feedback, to help provide a unified perception of language across modalities. This multimodal integration enhances speech comprehension by reinforcing auditory cues with corresponding tactile sensations, which may be particularly beneficial for users with hearing impairments. The coordinated feedback helps improve the ability to interpret complex auditory environments, improving overall communication effectiveness.

In some examples, a primary device may be utilized in the example of FIG. 3, as described in relation to FIG. 2.

In some embodiments, the haptic system 100, 200 or 300 of FIGS. 1-3 may use the techniques described herein to determine if a user (e.g., user 112 or user 302) changes their location with respect to user 110, and/or whether user 110 changes their location with respect to user 112 or user 302. For example, in the example of FIG. 1 or FIG. 2, haptic system 100 or 200 may determine, e.g., dynamically based on analyzed audio characteristics of user 112 or other sensor data or based on user input,, that user 112 is now on a right-hand side of user 110, and audio and haptic patterns may be output at, e.g., one or more haptic actuators on right-hand side of user 110 instead. As another example, haptic system 300 may determine, e.g., dynamically based on analyzed audio characteristics of user 302 or other sensor data or based on user input, that user 302 has moved to a same side as user 302 in relation to user 110, and may assign, e.g., a first device on a first side in relation to user 110 to output audio and/or haptic patterns for user 302, and a second device on the first side in relation to user 110 to output audio and/or haptic patterns for user 112.

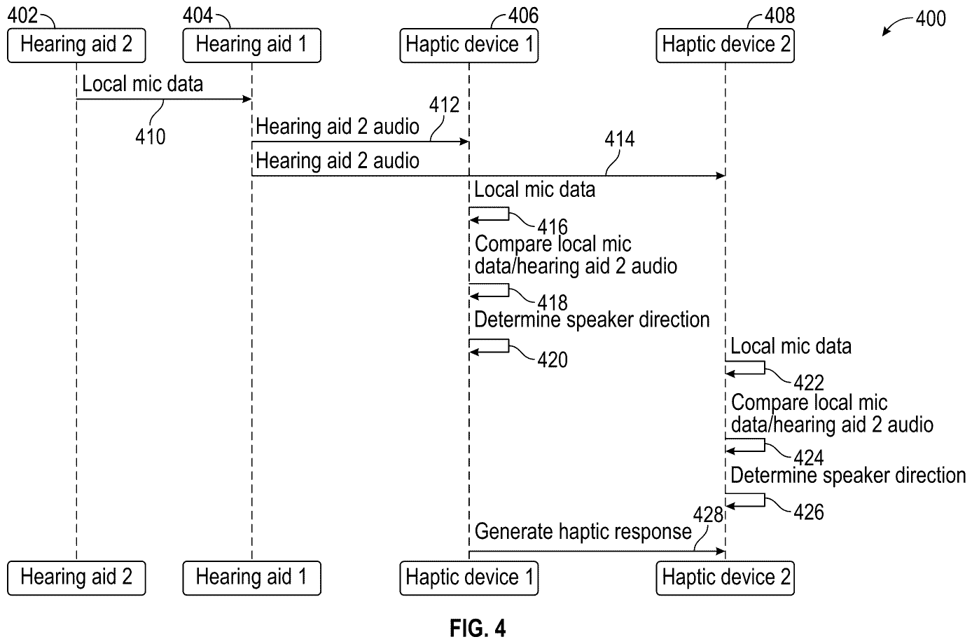

FIG. 4 is a sequence diagram for using a second device to acquire higher quality audio to generate a suitable directional haptic response, in accordance with some embodiments of the present disclosure. In some embodiments, system 400 includes second hearing aid 402, first hearing aid 404, first haptic device 406 (e.g., corresponding to haptic device 102 of FIG. 3), and second haptic device 408 (e.g., corresponding to haptic device 212 of FIG. 3). System 400 may include additional servers, devices, and/or networks, e.g., as discussed in relation to FIGS. 1-3 and 5-9. The processes or techniques of FIG. 4 may be used with any other embodiment of this disclosure. In addition, the processes and techniques described in relation to FIG. 4 may be done in suitable alternative orders or in parallel to further the purposes of this disclosure.

In some embodiments, a first user and a second user are both wearing a hearing aid (the first user is wearing first hearing aid 404, and the second user is wearing second hearing aid 402). First hearing aid 404 and second hearing aid 402 may have established a connection such as via, e.g., Bluetooth or Wi-Fi or any other suitable connection. At 410, second hearing aid 402 may detect, using a microphone associated with second hearing aid 402, the audio when the user wearing second hearing aid 402 speaks, and transit such audio data to first hearing aid 404 being worn by the first user. For example, second hearing aid 402 may recognize the voice of the second user, or otherwise determine based on analyzed audio signals that the second user is speaking. At 412, first hearing aid 404 may relay the audio data received at 404 to first haptic device 406 and/or second haptic device 408 (one of the haptic devices of the first user).

At 414, the first haptic device 406 may detect local microphone data, and compare such local microphone data to hearing audio received at 412. At 418, first haptic device 406 compares the local microphone data detected by first haptic device 406 with the second hearing aid audio. At 420, first haptic device 406 determines the direction of where the speaker is relative to first haptic device 406. At 422, second haptic device 408 processes local microphone data detected by second haptic device 408. At 424, second haptic device 408 compares the local microphone data detected by second haptic device 408 with the second hearing aid audio. At 426, second haptic device 408 determines the direction of where the speaker is relative to second haptic device 408. At 428, first haptic device 406 generates a haptic response at haptic device.

Such embodiments may help improve the voice quality in the audio used to generate the haptic pattern by selecting an audio source closer to the speaker (e.g., in their ear). In some embodiments, the haptic devices that receive that audio signal may then compare it to the audio signal they received locally and determine a most likely direction and/or direction of the audio, and/or may use the audio signal to generate the haptic response. In some embodiments, the haptic devices (e.g., first haptic device 406 and second haptic device 408) may determine the quality of the speech audio captured by the microphones (e.g., first hearing aid 404 and second hearing aid 402) and generate haptic patterns using audio captured by the microphone with the higher or highest quality. In some embodiments, microphone quality may be established by comparing product features via metadata (e.g., upper frequency limit, noise cancellation or isolation) or by analyzing the quality of the captured audio directly (e.g., signal to noise ratio, frequency response).

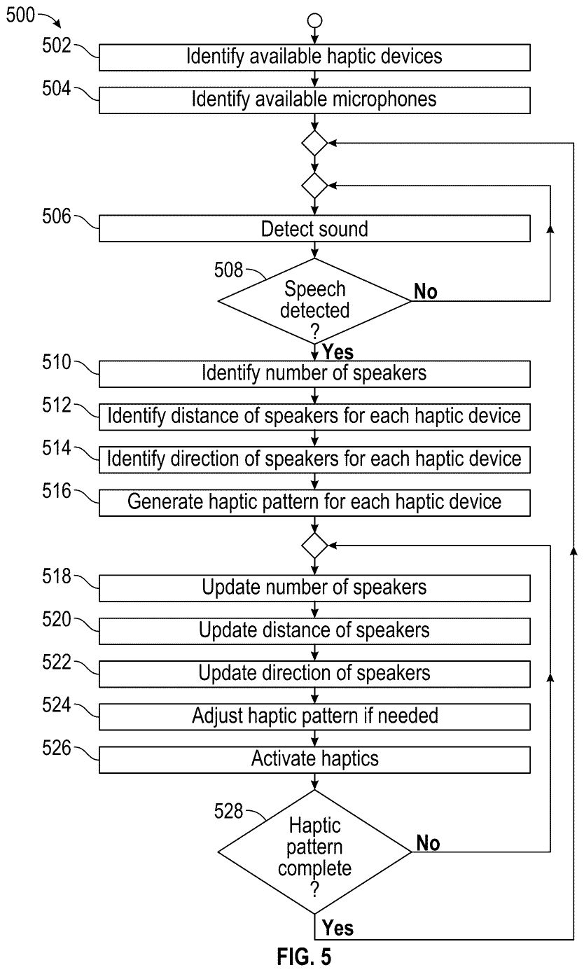

FIG. 5 is a flowchart of an illustrative process for enhancing speech comprehension with directional haptics, in accordance with some embodiments of the present disclosure. In various embodiments, the individual steps of process 500 may be implemented by haptic system 300 of FIG. 3, for example, using the control circuitry of haptic device 102 or second haptic device 212. For example, non-transitory memories of one or more components of haptic device 102 and second haptic device 212 and devices of FIGS. 8 and 9 (e.g., storage 914 and control circuitry 911) may store instructions that, when executed by the control circuitry of haptic device 102 and second haptic device 212 and devices of FIGS. 8 and 9 (as described further below with reference to FIGS. 8 and 9), cause execution of the process depicted in FIG. 5. The processes or techniques of FIG. 5 may be used with any other embodiment of this disclosure. In addition, the processes and techniques described in relation to FIG. 5 may be done in suitable alternative orders or in parallel to further the purposes of this disclosure.

At 502, the haptic system (e.g., haptic system 300 of FIG. 3) identifies available haptic devices in an environment. In some examples, the control circuitry of a primary device (that may itself be a haptic device or may not itself be a haptic device), such as, for example, a smartphone, identifies the available haptic devices that are associated with the primary device, e.g., through a linked iCloud or other cloud-based account, or connected by a Bluetooth or some other wired/wireless connection. At 504, the control circuitry identifies available microphones, e.g., one or more microphones 106, one or microphones 216, and one or more microphones 116 of FIG. 3.

At 506, the haptic system detects a sound in the environment, e.g., using the microphones. At 508, the haptic system determines whether speech was detected within the sound. In some embodiments, if speech was not detected at 508, process 500 returns to 506 to continue using one or more microphones to monitor for sound (e.g., human voices). In some embodiments, if speech is detected at 508, process 500 proceeds to 510.

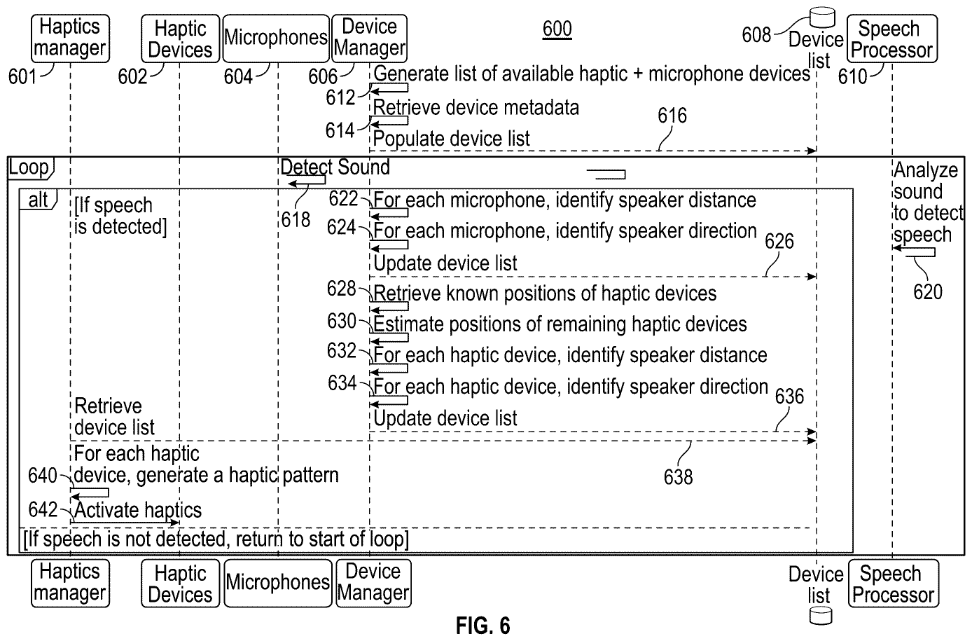

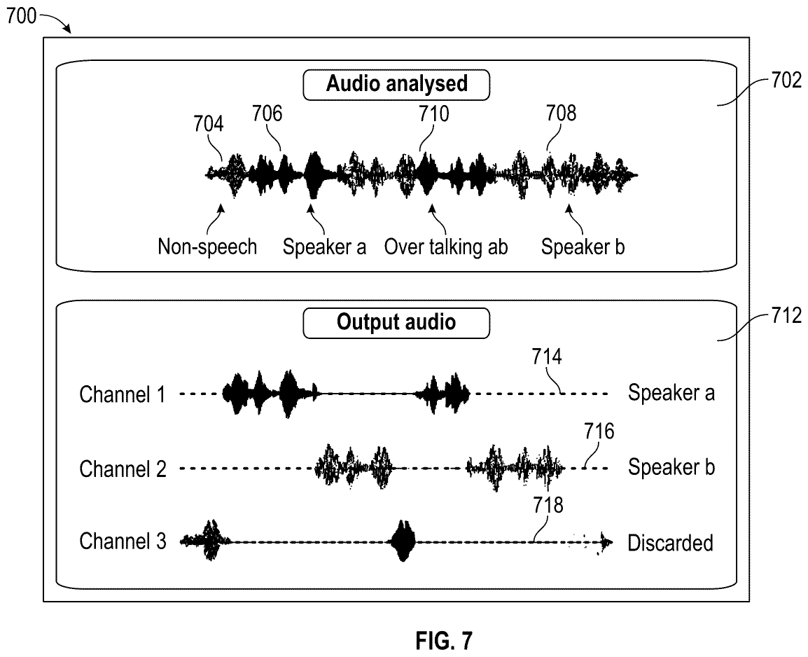

At 510, the haptic system identifies the number of speakers, as described further below with reference to FIG. 7. At 512, the haptic system identifies the distance between each identified speaker and each haptic device, as described further below with reference to FIG. 6. In some embodiments, step 512 may be optional, and in certain embodiments, any suitable step shown in FIG. 5 may be considered optional, and/or additional steps may be performed. At 514, the haptic system identifies the direction of each identified speaker relative to each haptic device, as described further below with reference to FIG. 6. At 516, the haptic system generates a haptic pattern for each haptic device, as described further above with reference to FIGS. 11-3.

At 518, the haptic system updates the number of speakers based on a detected change in speakers in the environment. At 518, the haptic system updates the distance between the new speakers and the haptic devices based on the detected change in speakers in the environment, as described further below with reference to FIG. 6. At 520, the haptic system updates the direction of the new speakers relative to the haptic devices based on the detected change in speakers in the environment, as described further below with reference to FIG. 6. At 524, the haptic system adjusts the haptic pattern generated at 516 (as appropriate) based on the detected change in speakers in the environment. At 526, the haptic system activates the haptics of the haptic devices based on the adjusted haptic pattern. At 528, the haptic system determines whether the haptic pattern has been completely actuated at the haptic devices. In some embodiments, at 528, if the haptic pattern has not been completely actuated at the haptic devices, process 500 returns to prior to 518. In some embodiments, at 528, if the haptic pattern has been completely actuated at the haptic devices, process 500 returns to after 504.

FIG. 6 is a sequence diagram for enhancing speech comprehension with directional haptics, in accordance with some embodiments of the present disclosure. In some embodiments, system 600 (which may correspond to haptic systems 100, 200, and/or 300 of FIGS. 1-3) includes haptics manager 601, haptic devices 602 (e.g., haptic device 102 and second haptic device 212 of FIG. 3), microphones 604 (e.g., one or more microphones 106, one or more microphones 206, and one or more microphones 116 of FIG. 3), device manager 606, device list database 608, and speech processor 610. In some embodiments, device manager 606 and/or haptics manager 601 is a primary device or is part of a primary device. In some examples, a primary device is a smartphone associated with the haptic devices, e.g., through a linked iCloud or other cloud-based account, or connected to the haptic devices by a Bluetooth or some other wired/wireless connection. In some examples, device manager 606 and/or haptics manager 601 is one of or part of one of haptic devices 602. System 600 may include additional servers, devices, and/or networks. The processes or techniques of FIG. 6 may be used with any other embodiment of this disclosure. In addition, the processes and techniques described in relation to FIG. 6 may be done in suitable alternative orders or in parallel to further the purposes of this disclosure.

At 612, device manager 606 generates a list of available haptic devices 602 and microphones 604. At 614, device manager 606 retrieves metadata for those devices. In some embodiments, the device metadata indicates which devices in an environment are haptic devices, for example, haptic devices 602 are indicated as haptic devices within the environment. At 616, device manager 606 populates the device list, including the metadata, and transmits it to device list database 608. At 618, microphones 604 detect sound. At 610, speech processor 610 analyzes the detected sound to detect speech. In some embodiments, if speech is not detected at 620, processing returns to 618 and continues monitoring for sound.

In some embodiments, if speech is detected at 620, processing proceeds to 622. At 622, device manager 606 identifies the distance between each of microphones 604 and each speaker generating the speech. At 624, device manager 606 identifies the direction of each speaker generating the speech relative to each of microphones 604. At 626, device manager 606 updates the device list at device list database 626 to include the direction and distance information for each of microphones 604. At 628, device manager 606 retrieves the known positions of any haptic devices of haptic devices 602 that device manager 606 knows the position of. At 630, device manager 606 estimates position information for any haptic devices of haptic devices 602 that device manager 606 does not know the position of. At 632, device manager 606 identifies the distance between each of haptic devices 602 and each speaker generating the speech. At 634, device manager 606 identifies the direction of each speaker generating the speech relative to each of haptic devices 602. At 636, device manager 606 updates the device list at device list database 626 to include the direction and distance information for each of haptic devices 602.

In some embodiments, for devices with both haptics and a microphone (or multiple microphones), device manager 606 may calculate microphone distance and direction from the speakers, which may, in some embodiments, be adjusted for the relative positions of haptics and microphones on the device. In some embodiments, for haptic devices that are not integrated with a microphone (e.g., Fitbit wristwatch), device manager 606 infers relative device position based on device metadata and features of a user wearing the devices (e.g., user 110 of FIG. 1). In some embodiments, device manager 606 determines the position and orientation of microphones 604 and haptic devices 602 using external sensors or inside-out tracking. In some examples, the external sensors and/or inside-out tracking may enable full 6DoF tracking (e.g., position and rotation), in which case device manager 606 may populate the list of devices for device list database 626 with XYZ coordinates. In some examples, once the positions of haptic devices 602 and microphones 604 are known, device manager 606 may calculate Time of Arrival and Direction of Arrival of speaker sounds by comparing detected sound amplitude and timing across multiple microphones. In some examples, if full position data is not available directly, device manager 606 may infer the relative position of a device that is not tracked via the device type (e.g., based on the inference that earbuds go in a user's ear, a watch goes on a user's wrist, etc.) or via device metadata (e.g., user 110 of FIG. 1 typically wears their smartwatch on their right hand). In some examples, such relative positions may be modified according to known user traits such as, for example, height and weight.

In some embodiments, inertial measurement units (IMU) data may be used to infer the position of embedded microphones with known positions on a device. For example, an Apple Watch, or other smartwatch or consumer electronics, may include microphones on both sides of the watch face, so one microphone may generally be closer to the speaker and therefore typically detect that speaker as louder. By tracking device rotation (e.g., if the user takes a sip of coffee using a same hand wearing the smartwatch) and retrieving device metadata that indicates the positions of the microphones relative to each other, device manager 606 may correctly identify that the watch is rotating, rather than the speaker moving.

At 638, haptics manager 601 retrieves the device list from device list database 626. At 640, haptics manager 601 generates a haptic pattern for each of haptic devices 602. At 642, haptics manager 601 activates the haptics at haptic devices 602 to actuate the haptic pattern.

In some embodiments, when two speakers are detected within a threshold angular distance (e.g., <30°), device manager 606 may adjust haptic patterns to exaggerate this distance. For example, two speakers in front of the user wearing the haptic devices having a conversation may only be 10° apart from the perspective of the user, which may result in minimal differences between detected audio signals and generated haptic patterns. In this example, having identified the direction of both speakers and associated audio signals, device manager 606 may amplify the haptic pattern associated with a first speaker for haptic user devices that are closer to such first speaker, and may amplify the haptic pattern associated with a second speaker for user devices that are closer to such second speaker. In some embodiments, using haptics to exaggerate the angular difference between speakers may improve the ability for a user to comprehend speech from multiple speakers spoken from similar directions.

In some embodiments, actuating haptics in real time, vibrating along with each word as it is spoken, may not be effective in some situations. For example, when someone is speaking very quickly or multiple people are speaking at once, the generated haptic pattern may be perceived as muddled or incongruous. In some embodiments, applying a slight delay (e.g., 250 msec-2 sec) as part of a delay mode implemented by the haptic system may enable additional processing to improve comprehension.

In some embodiments, rather than apply a consistent delay, device manager 606 may adjust the delay based on the estimated difficulty of comprehension. Such a measure may be based on the number of speakers, angular distance of speakers or users from each other, phonemes/sec, consonants/sec, words/sec, the confidence level associated with word classification, or the reading level associated with specific words, terms and/or sentences.

In some embodiments, in situations with a delay above a threshold defined by processing time, device manager 606 may identify a word and look up the pronunciation of the word in a dictionary database (e.g., locally stored). This may be useful where, for example, a language such as English emphasizes different sounds in different words (e.g., aMAZing, TRUly, uninTENded), but such emphasis may be lost when speaking quickly or depending on an individual's speaking style. In some examples, upon identifying the emphasized sounds of a word, device manager 606 may increase the strength of the generated haptic pattern in the period of the emphasized syllable.

In some embodiments, device manager 606 may synchronize auditory and haptic signals between haptic devices 602 and microphones 604. This synchronization can be achieved with a wireless communication link between the haptic devices 602 and microphones 604, using protocols such as Bluetooth Low Energy (BLE) or Near-Field Communication (NFC). Device manager 606 may use time-stamping and audio signal processing techniques to match the temporal characteristics of the auditory signals with the haptic feedback.

FIG. 7 is an illustrative example of speaker diarization extracting speech data for at least two speakers from a single audio source, in accordance with some embodiments of the present disclosure. In some embodiments, system 700 (which may correspond to haptic systems 100, 200, and/or 300 of FIGS. 1-3) includes original sound waveform 702 and output audio channels 712. In some embodiments, speaker diarization is performed by haptic system 300 of FIG. 3, for example, using the control circuitry of haptic device 102 or second haptic device 212. For example, non-transitory memories of one or more components of haptic device 102 or second haptic device 212 and devices of FIGS. 8 and 9, e.g., storage 914 and control circuitry 911, may store instructions that, when executed by the control circuitry of the device and devices of FIGS. 8 and 9 (as described further below with reference to FIGS. 8 and 9), cause execution of the speaker diarization process depicted in FIG. 7.

In some embodiments, the haptic system (e.g., haptic system 300 of FIG. 3) employs voice activity detection (VAD) to detect the presence of human speech, which can help improve speech processing by avoiding processing of non-speech sounds. VAD may balance latency, sensitivity, accuracy, and computational costs. In some embodiments, original sound waveform 702 visually depicts sound from audio data, e.g., speech 104 and speech 304 of FIG. 3. In some embodiments, output audio channels 712 includes a sound waveform depicting the audio for each distinct speaker represented in original sound waveform 702, including channel 1 sound waveform 714, channel 2 sound waveform 716, and channel 3 sound waveform 718. In some embodiments, original sound waveform 702 includes non-speech section 704, speaker A only section 706, speaker B only section 708, and speaker A and speaker B overtalking section 710 (e.g., a portion or section of audio with speaker A and B talking over each other).

In some implementations, sound waveform 714 (corresponding to channel 1) depicts only amplitude signals for speaker A only section 706, as speaker A audio. In some implementations, sound waveform 716 (corresponding to channel 2) depicts only amplitude signals for speaker B only section 708, as speaker B audio. In some embodiments, sound waveform 718 (corresponding to channel 3) depicts non-speech section 704, and speaker A and speaker B overtalking section 710, as discarded audio.

In some embodiments, speaker diarization segments audio recordings by speaker labels to identify how many speakers are present in an audio recording. In some embodiments, the haptic system may use a low-compute speech detector to identify human speech. A low-compute speech detector minimizes resource requirements (such as battery power and memory) while still identifying speech. For example, a typical hearing aid usually employes low-compute speech detectors. Low compute speech detectors can detect and process audio in real-time in contained (e.g., small rooms without much background noise) environments. In such examples, if human speech is detected, the haptic system may activate a more complex speech processing mode to identify specific words. A complex speech detector may go beyond basic voice activity detection to detect and process speech in complex scenarios, for example, outdoor environments with background noise and multiple speakers. More complex speech detectors may have natural language processing and automatic speech recognition capabilities, as well as an increased memory capacity to process speech over longer periods of time.

In some embodiments, upon detecting multiple speakers, the haptic system may apply voice fingerprinting methods to generate voice profiles for each detected speaker. In some embodiments, the haptic system stores voice fingerprints for people in the memory of a primary device (e.g., haptic device 102 of FIG. 1), as described further above with reference to FIG. 1. In some implementations, distinct voices are extracted from audio data captured by the microphones (e.g., one or more microphones 106 of FIG. 1) for example, using calibration, sound level, and spectrum measurement. In some examples, the haptic system stores captured audio into a combination of indexes representing a speaker and the portion of their speech. In some embodiments, voice fingerprints are computed in real time to associate an audio segment with a detected voice. In some implementations, voice fingerprints are weights of a machine learning model used to discriminate speakers in a conversation. In some embodiments, voice fingerprints are spectral representations of voices that are matched to spectral representations of a conversation. In some embodiments, voice fingerprints are preconfigured by users to be prestored by the primary device for future conversations. For example, when setting up the primary device of the haptic system, the user associated with the primary device (e.g., user 110 of FIG. 1) pre-stores their own voice fingerprint and voice fingerprints of their family members by recording answers to prompts offered in the settings of the primary device.

In some embodiments, when the haptic system detects a voice a certain number of times over a predetermined threshold amount that does not already have a voice fingerprint stored for it, the haptic system creates and stores a new voice fingerprint for the voice. In some embodiments, the threshold amount is preconfigured by the user in the settings of the primary device. In some embodiments, when the haptic system detects a voice a certain number of times over a predetermined threshold amount that does not already have a voice fingerprint stored for it and the storage of the primary device does not have enough capacity for new voice fingerprints, the haptic system identifies the number of user inputs associated with each existing voice fingerprint and removes the voice fingerprint with the fewest number of user inputs associated with it before storing the voice of the new user in the memory. In some embodiments, voice fingerprints come from external devices, rather than being a learned fingerprint, for example, a technologically generated voice from a mobile device for a user that is speech impaired. For example, a voice fingerprint is transferred from one device, the device of a speech-impaired user, to the devices within the haptic system by the haptic system capturing an audio recording of the technologically generated voice from the device of the speech impaired user, or via an internet communication, e.g., email, text message, or file sharing. In some implementations, upon detecting that a portion of a captured audio stream matches a voice profile, the haptic system may apply speaker-specific modifications to the audio stream of the selected speaker and resulting haptic pattern.

In an embodiment, the haptic system allows users to associate voices of specific important individuals—such as, for example, those of a spouse or child-with dedicated haptic actuators through speaker recognition. In some embodiments, when the haptic system detected that one or more selected persons speak, their voices may consistently trigger the same haptic device/actuator on the body of the user, regardless of the physical location of the speaker or direction relative to the user.

In some embodiments, a person wearing a haptic device (e.g., haptic device 102 of FIG. 3) may indicate a desire to focus on a speaker using a gesture (e.g., eye gaze, head turn, finger point, voice input) or device interaction (e.g., select from a list of recent speakers, tap the device nearest the speaker). The integration of IMUs with haptic devices enables multiple devices to coordinate haptics depending on position and orientation. In some embodiments, directional haptics are used to indicate the direction of a sound source. In some embodiments, when using selection methods that rely on speaker direction, the haptic system may identify the direction of the detected gesture and the speaker whose direction most closely matches the detected gesture direction. In some embodiments, once a focused speaker has been identified, the haptic system may amplify haptic patterns associated with that speaker or reduce haptic patterns associated with other speakers.

In some embodiments, the haptic system integrates detected speaker gestures into generated haptic patterns. Cameras or motion sensors may detect gestures of one or more speakers and body language of the one or more speakers, and the haptic system may modify the generated haptic pattern (e.g., frequency or amplitude modulations) in response. For example, the haptic system may detect that a speaker makes emphatic hand gestures and increase the amplitude of the generated haptic pattern in response. This allows the user to perceive not only the spoken words but also the emotional emphasis and intent behind them. Integrating gesture information into haptic feedback may enhance communication by conveying non-verbal cues, which may assist in comprehension of a conversation.

In some embodiments, the haptic system detects emergency alerts or keywords such as, for example, “help!” or “fire!,” and responds by amplifying the haptic patterns or signals associated with these words, as compared to haptic patterns or signals for keywords in the conversation having been determined not to be related to an emergency or not to be a keyword. For example, emphasize the importance of the emergency term(s) or keyword(s), the haptic system may activate all available actuators simultaneously, providing a strong, noticeable tactile sensation that can help immediately capture the attention of the user. For example, such heightened haptic response may help allow urgent or life-threatening information to be promptly and effectively communicated to the user, enhancing safety and situational awareness.

In some embodiments, once a speaker has been identified via speaker diarization, the haptic system may apply any suitable sound localization methods on portions of audio featuring that speaker. Sound localization finds the source of sound with respect to an array of microphones. The distance of a speaker from each microphone may be determined by comparing the Time Difference of Arrival (TDoA) of detected sounds across microphones. Similar methods may be used to calculate Direction of Arrival (DoA) for each microphone. In some embodiments, taken together, these techniques may populate a list of microphones with estimated distance and direction of speakers, as well as confidence values for each estimate. The resulting list may be updated at a fixed rate (e.g., 1 Hz) or at an adaptive rate that changes based on the frequency of speaker changes or sound source direction changes above a threshold (e.g., 5°/sec).

FIGS. 8 and 9 describe example devices, systems, servers, and related hardware for enhancing speech comprehension with directional haptics, in accordance with some embodiments of the present disclosure. FIG. 8 shows generalized embodiments of illustrative devices 800 and 801. For example, devices 800 and 801 may be smartphone devices, smart glasses, smartwatches, smart speakers, hearing devices, voice assistants or any other haptic device with microphones or haptic actuators. Device 801 may be a smartwatch 816, for example. Smartwatch 816 may be communicatively connected to microphone 818, speakers 814, and display 812. In some embodiments, microphone 818 may receive voice commands. In some embodiments, display 812 may be an optional display on the smartwatch 816. In some embodiments, smartwatch 816 may be communicatively connected to user input interface 810. In some embodiments, user input interface 810 may be a remote-control device. Smartwatch 816 may include one or more circuit boards. In some embodiments, the circuit boards may include processing circuitry, control circuitry, and storage (e.g., RAM, ROM, Hard Disk, Removable Disk, etc.). In some embodiments, the circuit boards may include an input/output path. More specific implementations of devices are discussed below in connection with FIG. 8. Each one of devices 800 and 801 may receive data via input/output (“I/O”) path 802. I/O path 802 may provide data to control circuitry 804, which includes processing circuitry 806 and storage 808. Control circuitry 804 may be used to send and receive commands, requests, and other suitable data using I/O path 802, which may comprise I/O circuitry. I/O path 802 may connect control circuitry 804 (and specifically processing circuitry 806) to one or more communications paths (described below). I/O functions may be provided by one or more of these communications paths but are shown as a single path in FIG. 8 to avoid overcomplicating the drawing. In some embodiments, devices 800 and 801 of FIG. 8 (and user equipment 907, 908 and/or 910) may include one or more haptic actuators, e.g., linear resonant actuators (LRAs), piezoelectric actuators, eccentric rotating mass (ERM) motors, any other suitable motor or haptic actuator, or any combination thereof. Such haptic actuators may correspond to the haptic actuators described in relation to FIGS. 1-7.

Control circuitry 804 may be based on any suitable processing circuitry such as processing circuitry 806. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 804 executes instructions for the haptic system are stored in memory (e.g., storage 808). Specifically, control circuitry 804 may be instructed by the enhancing speech comprehension with haptics application to perform the functions discussed above and below. In some implementations, any action performed by control circuitry 804 may be based on instructions received from the enhancing speech comprehension with haptics application.

In client/server-based embodiments, control circuitry 804 may include communications circuitry suitable for communicating with networks or servers. The instructions for carrying out the above-mentioned functionality may be stored on a server (which is described in more detail in connection with FIG. 8). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the internet or any other suitable communication networks or paths (which is described in more detail in connection with FIG. 8). In addition, communications circuitry may include circuitry that enables peer-to-peer communication of devices, or communication of devices in locations remote from each other (described in more detail below).

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, recorders, solid state devices, quantum storage devices, or any other suitable fixed or removable storage devices, and/or any combination of the same. Storage 808 may be used to store various types of content described herein as well as data described above. Nonvolatile memory may also be used (e.g., to launch a boot-up routine and other instructions). Cloud-based storage, described in relation to FIG. 8, may be used to supplement storage 808 or instead of storage 808.

Control circuitry 804 may also include scaler circuitry for upconverting and downconverting content into the preferred output format of device 800. Circuitry 804 may also include digital-to-analog converter circuitry and analog-to-digital converter circuitry for converting between digital and analog signals. The circuitry described herein may be implemented using software running on one or more general purpose or specialized processors.

A user may send instructions to control circuitry 804 using user input interface 810. User input interface 810 may be any suitable user interface, such as a remote control, mouse, trackball, keypad, keyboard, touch screen, touchpad, stylus input, joystick, voice recognition interface, or other user input interfaces. In some embodiments, user input interface 810 is composed of capacitive touch technology, resistive touch technology, or proximity sensors. Display 812 may be provided as a stand-alone device or integrated with other elements of each one of device 800 and device 801. For example, display 812 may be a touchscreen or touch-sensitive display. In such circumstances, user input interface 810 may be integrated with or combined with display 812. Display 812 may be one or more of a monitor, a television, a display for a mobile device, or any other type of display. A video card or graphics card may generate the output to display 812. The video card may be any processing circuitry described above in relation to control circuitry 804. The video card may be integrated with the control circuitry 804. Speakers 814 may be provided as integrated with other elements of each one of device 800 and device 801 or may be stand-alone units. The audio component of videos and other content displayed on display 812 may be played through the speakers 814. In some embodiments, the audio may be distributed to a receiver (not shown), which processes and outputs the audio via speakers 814.

The haptic system may be implemented using any suitable architecture. For example, it may be a stand-alone application wholly implemented on each one of device 800 and device 801. In such an approach, instructions of the haptic system are stored locally (e.g., in storage 808), and data for use by the enhancing speech comprehension with haptics application is downloaded on a periodic basis (e.g., from an out-of-band feed, from an internet resource, or using another suitable approach). Control circuitry 804 may retrieve instructions of the haptic system from storage 808 and process the instructions to rearrange the segments as discussed. Based on the processed instructions, control circuitry 804 may determine what action to perform when input is received from user input interface 810. For example, movement of a cursor on a display up/down may be indicated by the processed instructions when user input interface 810 indicates that an up/down button was selected.

In some embodiments, the haptic system is a client/server-based application. Data for use by a thick or thin client implemented on each one of device 800 and device 801 is retrieved on-demand by issuing requests to a server remote to each one of device 800 and device 801. In one example of a client/server-based guidance application, control circuitry 804 runs a web browser that interprets web pages provided by a remote server. For example, the remote server may store the instructions for the enhancing speech comprehension with haptics application in a storage device. The remote server may process the stored instructions using circuitry (e.g., control circuitry 804) to perform the operations discussed in connection with FIGS. 1-7 and 10.

In some embodiments, the haptic system may be downloaded and interpreted or otherwise run by an interpreter or virtual machine (run by control circuitry 804). In some embodiments, the haptic system may be encoded in the ETV Binary Interchange Format (EBIF), received by the control circuitry 804 as part of a suitable feed, and interpreted by a user agent running on control circuitry 804. For example, the haptic system may be an EBIF application. In some embodiments, the haptic system may be defined by a series of JAVA-based files that are received and run by a local virtual machine or other suitable middleware executed by control circuitry 804. In some of such embodiments (e.g., those employing MPEG-2 or other digital media encoding schemes), the haptic system may be, for example, encoded and transmitted in an MPEG-2 object carousel with the MPEG audio and/or video packets of a program.

FIG. 9 is a diagram of an illustrative system for enhancing speech comprehension with directional haptics, in accordance with some embodiments of the disclosure. Devices 907, 908, 910 (e.g., haptic device 102 and second haptic device 212 of FIG. 3, which may be smartphone devices, smart speakers, smartwatches, or earpieces) may be coupled to communication network 906. Communication network 906 may be one or more networks including the internet, a mobile phone network, mobile voice, or data network (e.g., a 4G or LTE network), cable network, public switched telephone network, or other types of communication network or combinations of communication networks. Paths (e.g., depicted as arrows connecting the respective devices to the communication network 906) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 9 to avoid overcomplicating the drawing.

Although communications paths are not drawn between devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The devices may also communicate with each other directly through an indirect path via communication network 906.

System 900 includes a media content source 902 and a server 904, which may comprise or be associated with database 905. Communications with media content source 902 and server 904 may be exchanged over one or more communications paths but are shown as a single path in FIG. 9 to avoid overcomplicating the drawing. In addition, there may be more than one of each of media content source 902 and server 904, but only one of each is shown in FIG. 9 to avoid overcomplicating the drawing. If desired, media content source 902 and server 904 may be integrated as one source device.

In some examples, the processes outlined within system 900 are performed by one of devices 907-910. In some embodiments, server 904 may include control circuitry 911 and a storage 914 (e.g., RAM, ROM, Hard Disk, Removable Disk, etc.). In some embodiments, storage 914 may store instructions that when, executed by control circuitry 911, may cause control circuitry 911 to execute the steps outlined within system 900. Server 904 may also include an input/output path 912. I/O path 912 may provide device information, or other data, over a local area network (LAN) or wide area network (WAN), and/or other content and data to the control circuitry 911, which includes processing circuitry, and storage 914. The control circuitry 911 may be used to send and receive commands, requests, and other suitable data using I/O path 912, which may comprise I/O circuitry. I/O path 912 may connect control circuitry 911 (and specifically processing circuitry) to one or more communications paths.

Control circuitry 911 may be based on any suitable processing circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 911 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, the control circuitry 911 executes instructions for an emulation system application stored in memory (e.g., the storage 914). Memory may be an electronic storage device provided as storage 914 that is part of control circuitry 911.

Server 904 may retrieve data from media content source 902, process the data as will be described in detail below, and forward the data to devices 907 and 910. Media content source 902 may include one or more types of content distribution equipment including, for example, intermediate distribution facilities and/or servers, internet providers, on-demand media servers, and other content providers. Media content source 902 may include satellite providers, on-demand providers, internet providers, over-the-top content providers, or other providers of content. Media content source 902 may also include a remote media server used to store different types of content (including video content selected by a user), in a location remote from any of the client devices. Media content source 902 may also provide metadata that can be used to identify important segments of media content as described above. Any one of devices 907-910 may also be the originator of data (e.g., recorded conversations).

Client devices may operate in a cloud computing environment to access cloud services. In a cloud computing environment, various types of computing services for content sharing, storage or distribution are provided by a collection of network-accessible computing and storage resources, referred to as “the cloud.” For example, the cloud can include a collection of server computing devices (such as, e.g., server 904), which may be located centrally or at distributed locations, that provide cloud-based services to various types of users and devices connected via a network such as the internet via communication network 906. In such embodiments, devices may operate in a peer-to-peer manner without communicating with a central server.

Throughout the specification, the phrases “in response to” and “based on” shall be understood to have a broad meaning unless context requires otherwise. For example, “in response to” may refer to a step that is in direct or indirect response to a prior step, and “based on” may refer to a step that is based at least in part on a prior step or on another factor.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
identifying a plurality of haptic actuators, wherein the plurality of haptic actuators are associated with a user;
detecting, using one or more microphones, audio data comprising speech;
identifying a direction of a source of the speech relative to the plurality of haptic actuators;
determining a haptic pattern corresponding to the speech; and
based at least in part on the identified direction: identifying one or more haptic actuators of the plurality of haptic actuators; and causing, by control circuitry, output of the haptic pattern at the identified one or more haptic actuators of the plurality of haptic actuators.

2. The method of claim 1, wherein:
one or more first haptic actuators of the plurality of haptic actuators are included in a first device;
one or more second haptic actuators of the plurality of haptic actuators are included in a second device; and
the identifying of the one or more first haptic actuators and the one or more second haptic actuators is based at least in part on the identified direction in relation to a location of the first device and a location of the second device.

3. The method of claim 2, wherein the speech is first speech spoken by a first speaker, the direction is a first direction, the haptic pattern is a first haptic pattern, the one or more first haptic actuators correspond to the one or more first haptic actuators configured to output haptic patterns associated with the first speaker, the method further comprising:
identifying a second speaker of second speech in the audio data, wherein each of the user, the first speaker, and the second speaker is distinct from each other;
identifying a second direction of the second speaker relative to the plurality of haptic actuators;
determining a second haptic pattern corresponding to the second speech; and causing, by the control circuitry, output of the second haptic pattern at the one or more second haptic actuators, wherein the one or more second haptic actuators contact a different portion of the user than the one or more first haptic actuators.

4. The method of claim 1, wherein the speech is first speech spoken by a first speaker, the direction is a first direction, the haptic pattern is a first haptic pattern, each of the plurality of haptic actuators is included in a device, and the one or more haptic actuators are included in a first subset of the plurality of haptic actuators configured to output haptic patterns associated with the first speaker, the method further comprising:
identifying a second speaker of second speech in the audio data, wherein each of the user, the first speaker, and the second speaker is distinct from each other;
identifying a second direction of the second speaker relative to the plurality of haptic actuators;
determining a second haptic pattern corresponding to the second speech; and causing, by the control circuitry, output of the second haptic pattern at a second subset of the plurality of haptic actuators, wherein the second subset is configured to output haptic patterns from the second speaker, and wherein the second subset of the plurality of haptic actuators contacts a different portion of the user than the first subset of the plurality of haptic actuators.

5. The method of claim 1, wherein the plurality of haptic actuators is a first plurality of haptic actuators, a first device comprises the first plurality of haptic actuators, the haptic pattern is a first haptic pattern, and the direction is a first direction, the method further comprising:
determining that the speech is first speech spoken by a first speaker, wherein the first speaker is distinct from the user;
identifying a second device, wherein the second device comprises a second plurality of haptic actuators;
detecting the audio data further comprises detecting second speech spoken by a second speaker, wherein the second speaker is distinct from the user and from the first speaker;
based at least in part on the detecting the audio data comprising the second speech: identifying a second direction of the second speaker relative to the second plurality of haptic actuators; and determining a second haptic pattern corresponding to the second speech; and
based at least in part on the second direction: identifying one or more of the second plurality of haptic actuators; and causing, by the control circuitry, the output of the second haptic pattern at the identified one or more of the second plurality of haptic actuators.

6. The method of claim 5, wherein the second direction is different than the first direction.

7. The method of claim 5, wherein at least a portion of the first speech is spoken by the first speaker while at least a portion of the second speech is spoken by the second speaker.

8. The method of claim 7, further comprising:
receiving input indicative of a selection of the first speaker; and
based at least in part on the received input, causing the output of the first haptic pattern to be emphasized over the output of the second haptic pattern.

9. The method of claim 1, wherein the control circuitry is included in a first device, and a second device comprises the plurality of haptic actuators, the second device being distinct from the first device.

10. The method of claim 1, further comprising:
determining a change in the identified direction; and
adjusting the output of the haptic pattern at the identified one or more of the plurality of haptic actuators based at least in part on the determined change.

11. The method of claim 1, further comprising:
determining a change in an orientation of the plurality of haptic actuators,
wherein the adjusting of the output of the haptic pattern at the identified one or more of the plurality of haptic actuators is based at least in part on the determined change in the orientation.

12. The method of claim 1, further comprising:
detecting one or more emphasized words within the speech; and
wherein the causing, by the control circuitry, the output of the haptic pattern is based at least in part on the one or more emphasized words.

13. The method of claim 1, wherein the haptic pattern is output while the speech is detected.

14. The method of claim 1, wherein the determining the haptic pattern corresponding to the speech further comprises:
determining that the speech is spoken by a speaker;
determining an identity of the speaker; and
determining the haptic pattern based at least in part on the identity of the speaker.

15. The method of claim 14, further comprising:
determining whether the identity of the speaker matches stored information corresponding to distinct speaker identities; and
determining the haptic pattern based on preferences stored in a user profile for a particular speaker identity.

16. The method of claim 14, wherein the determining the haptic pattern corresponding to the speech is further based on physical gestures of the speaker.

17. The method of claim 1, further comprising:
identifying a distance between the source of the speech and the plurality of haptic actuators; and
wherein the identifying of the one or more haptic actuators and the causing of the output of the haptic pattern at the identified one or more haptic actuators is further based at least in part on the identified distance.

18. A system comprising:
control circuitry configured to:
identify a plurality of haptic actuators, wherein the plurality of haptic actuators are associated with a user;
detect, using one or more microphones, audio data comprising speech;
identify a direction of a source of the speech relative to the plurality of haptic actuators;
determine a haptic pattern corresponding to the speech; and
based at least in part on the identified direction: identify one or more haptic actuators of the plurality of haptic actuators; and cause output of the haptic pattern at the identified one or more haptic actuators of the plurality of haptic actuators.

19. The system of claim 18, wherein:
one or more first haptic actuators of the plurality of haptic actuators are included in a first device;
one or more second haptic actuators of the plurality of haptic actuators are included in a second device; and
the control circuitry is further configured to identify the one or more first haptic actuators and the one or more second haptic actuators based at least in part on the identified direction in relation to a location of the first device and a location of the second device.

20. The system of claim 19, wherein the speech is first speech spoken by a first speaker, the direction is a first direction, the haptic pattern is a first haptic pattern, the one or more first haptic actuators correspond to the one or more first haptic actuators configured to output haptic patterns associated with the first speaker, and the control circuitry is further configured to:
identify a second speaker of second speech in the audio data, wherein each of the user, the first speaker, and the second speaker is distinct from each other;
identify a second direction of the second speaker relative to the plurality of haptic actuators;
determine a second haptic pattern corresponding to the second speech; and
cause output of the second haptic pattern at the one or more second haptic actuators, wherein the one or more second haptic actuators contact a different portion of the user than the one or more first haptic actuators.

21.-85. (canceled)
